(19) United States
(12) Patent Application Publication
(10) Pub. No.: US 2020/0010179 A1
(43) Pub. Date: Jan. 9, 2020

(54) RTK ANTENNA MOUNTING BRACKET AND UNMANNED AERIAL VEHICLE

(71) Applicant: SZ DJI TECHNOLOGY CO., LTD., Shenzhen (CN)

(72) Inventors: Yucheng LIU, Shenzhen (CN); Li QIU, Shenzhen (CN)

(21) Appl. No.: 16/549,551

(22) Filed: Aug. 23, 2019

Related U.S. Application Data
(63) Continuation of application No. PCT/CN2017/074759, filed on Feb. 24, 2017.

(51) Int. Cl. B64C 25/26; B64D 43/00; B64C 25/34

(52) U.S. Cl. CPC B64C 25/26; B64D 43/00; B64C 39/00; B64C 2201/18; B64C 25/34

(57) ABSTRACT

The present disclosure provides an UAV. The UAV includes a body; a landing gear for supporting the body when the UAV is landing; and an antenna mounting bracket connected to the landing gear. The antenna mounting gear includes a mounting base for mounting an RTK antenna; a mounting bracket that is connected to the mounting base; and a landing gear base for connecting to the landing gear, the landing gear base being rotatably connected to the mounting bracket. The mounting bracket is in an extended state when the RTK antenna and the landing gear are respectively located on an upper and a lower side of the landing gear base; and the mounting bracket is in a folded state when the RTK antenna and the landing gear base are on the same side of the landing gear base.

### CROSS-REFERENCE TO RELATED APPLICATION

This application is a continuation application of International Application No. PCT/CN2017/074759, filed on Feb. 24, 2017, the entire content of which is incorporated herein by reference.

### TECHNICAL FIELD

The present disclosure relates to the field of aircraft technology, and more specifically, to a Real-Time Kinematic (RTK) antenna mounting bracket and an Unmanned Aerial Vehicle (UAV).

### BACKGROUND

Real-Time Kinematic technique is a method for processing the difference of the observed carrier phase of two measuring stations in real time, in which a carrier phase collected by a base station is transmitted to a user's receiving device to perform the difference calculation to identify the coordinates. With the continued development of the RTK technology, the application of an RTK antenna has become more and more extensive.

As a new means for positioning, onboard RTK antenna is increasingly being used in UAVs, which has greatly improved the positioning and navigation accuracy of the UAVs. At the same time, the installation requirements of the antenna spacing and the antenna height of the onboard RTK antenna are acceptable when it is installed on a relatively large UAV by using fixed brackets.

However, for smaller UAVs with certain portability requirements, the relatively large fixed onboard antenna mounting bracket may have a significant impact on the portability. Therefore, in order to ensure the portability of the UAV, a small fixed mounting bracket is required. However, the smaller fixed mounting bracket may not meet the corresponding installation requirements of the onboard RTK antenna, which may affect the performance of the RTK antenna.

### SUMMARY

The present disclosure provides an RTK antenna mounting bracket and an UAV that may be used to meet the UAV portability requirement and ensure the RTK antenna's operational quality at the same time.

One aspect of the present disclosure provides an UAV. The UAV includes a body; a landing gear for supporting the body when the UAV is landing; and an antenna mounting bracket connected to the landing gear. The antenna mounting gear includes a mounting base for mounting an RTK antenna; a mounting bracket that is connected to the mounting base; and a landing gear base for connecting to the landing gear, the landing gear base being rotatably connected to the mounting bracket. The mounting bracket is in an extended state when the RTK antenna and the landing gear are respectively located on an upper and a lower side of the landing gear base; and the mounting bracket is in a folded state when the RTK antenna and the landing gear base are on the same side of the landing gear base.

The RTK antenna mounting bracket and the UAV provided in the present disclosure may realize the switching between the extended state and the folded state of the mounting bracket by adjusting the connection position or the connection state of the mounting bracket and the landing gear base. More specifically, when the RTK antenna and the landing gear are respectively located on the upper and lower sides of the landing gear base, the mounting bracket may be in the extended state; when the RTK antenna and the landing gear are on the same side of the landing gear base, the mounting bracket may be in the folded state. As such, the portability requirement of the UAV may be met and the operational quality and the practically of the RTK antenna may be ensured, which may be beneficial to the promotion and application of the market.

### BRIEF DESCRIPTION OF THE DRAWINGS

For a more complete understanding of the present disclosure and its advantages, reference is now made to the following description, taken in conjunction with the accompanying drawings, in which:

FIG. 1 is a schematic diagram of a connection structure between an RTK antenna mounting bracket and a landing gear according to an embodiment of the present disclosure;

FIG. 2 is a schematic diagram of a folding structure of an RTK antenna mounting bracket according to an embodiment of the present disclosure;

FIG. 3 is a side view of an RTK antenna mounting bracket and a landing gear according to an embodiment of the present disclosure;

FIG. 4 is a cross-sectional view along line A-A of FIG. 3;

FIG. 5 is an enlarged view of A in FIG. 4;

FIG. 6 is a schematic diagram of another connection structure between an RTK antenna mounting bracket and a landing gear according to an embodiment of the present disclosure;

FIG. 7 is an enlarged view of B in FIG. 6; and

FIG. 8 is a schematic structural diagram of an UAV according to an embodiment of the present disclosure.

It should be noted that the reference numerals shown in the drawings are described as follows:

| | |
|---|---|
| Mounting base | 1 |
| Mounting plate | 101 |
| Connecting rod | 102 |
| Mounting bracket | 2 |
| Landing gear base | 3 |
| Connecting base | 301 |
| Sleeve | 302 |
| RTK antenna | 4 |
| Landing gear | 5 |
| Rotating shaft | 6 |
| State locking device | 7 |
| Fixed knob | 701 |
| Fixed screw | 7011 |
| Fixed rotating head | 7012 |
| Landing gear quick release latch | 8 |
| Clamping mechanism | 801 |
| First hoop | 8011 |
| Second hoop | 8012 |
| Control mechanism | 802 |
| Rotating shaft | 8021 |
| Handle | 8022 |
| Cam | 8023 |
| First wheel portion | 80231 |
| Second wheel portion | 80232 |
| Body connection portion | 9 |
| Rotation positioning mechanism | 10 |
| Positioning base | 1001 |
| Limiting protrusion | 1002 |
| Limiting groove | 1003 |
| Spacer | 11 |
| Body | 100 |

### DETAILED DESCRIPTION OF THE EMBODIMENTS

In order to make the objectives, technical solutions, and advantages of the present disclosure clearer, the technical solutions in the embodiments of the present disclosure will be described below with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

In the description of the present disclosure, unless specified or limited otherwise, it should be noted that, terms “mounted,” “connected,” “coupled,” and “fastened” may be understood broadly, such as permanent connection, detachable connection, or integral connection. Those having ordinary skills in the art should understand the specific meanings in the present disclosure according to specific use cases.

In the description of the present disclosure, it should be understood that the terms “first,”, “second,” etc. are only used to indicate different components, but do not indicate or imply the order, the relative importance, or the number of the components. Thus, the term “first,” or “second” preceding a feature explicitly or implicitly indicates one or more of such feature.

Unless otherwise defined, all the technical and scientific terms used in the present disclosure have the same or similar meanings as generally understood by one of ordinary skill in the art. As described in the present disclosure, the terms used in the specification of the present disclosure are intended to describe example embodiments, instead of limiting the present disclosure.

Exemplary embodiments will be described with reference to the accompanying drawings. In the case where there is no conflict between the exemplary embodiments, the features of the following embodiments and examples may be combined with each other.

### First Embodiment

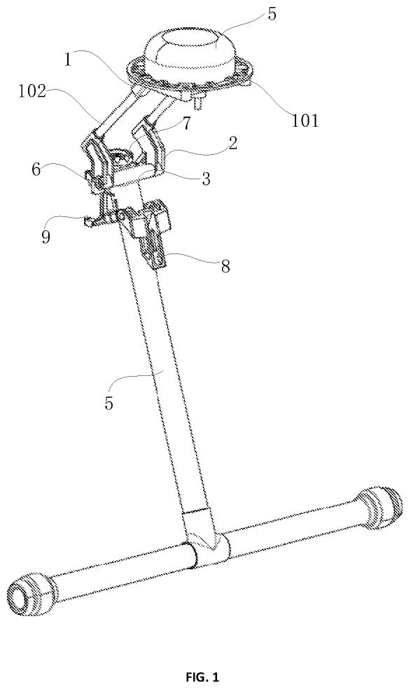

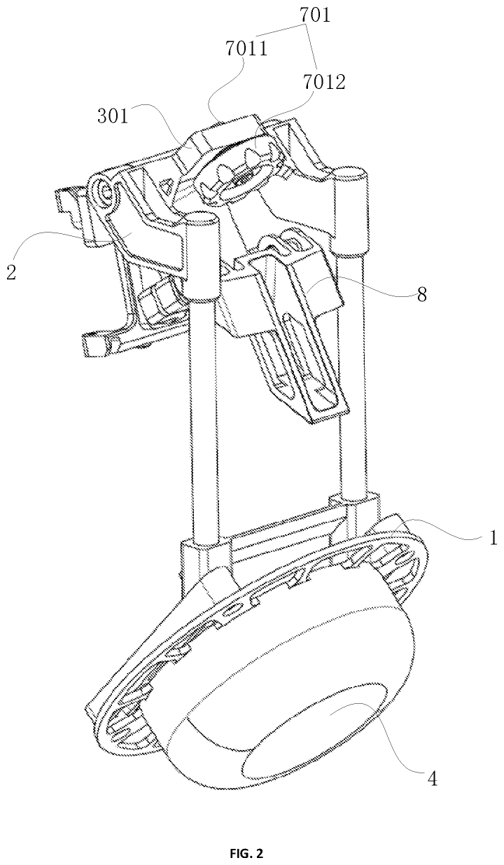

FIG. 1 is a schematic diagram of a connection structure between a mounting bracket 2 of an RTK antenna 4 and a landing gear 5 according to an embodiment of the present disclosure; and FIG. 2 is a schematic diagram of a folding structure of the mounting bracket 2 of the RTK antenna 4 according to an embodiment of the present disclosure. As can be seen from FIG. 1 and FIG. 2, the present embodiment provides the mounting bracket 2 of the RTK antenna 4. The antenna mounting bracket may be used to mount the RTK antenna 4 on an UAV with certain portability requirements and may ensure the quality of operation of the RTK antenna 4. More specifically, the antenna mounting bracket may include:

A mounting base 1 for mounting the RTK antenna 4.

A mounting bracket 2 that may be connected to the mounting base 1.

A landing gear base 3 that may be connected to the landing gear 5, and the landing gear base 3 may be rotatably connected to the mounting bracket 2.

More specifically, when the RTK antenna 4 and the landing gear 5 are respectively located on the upper and lower sides of the landing gear base 3, the mounting bracket 2 may be in an extended state; when the RTK antenna 4 and the landing gear 5 are on the same side of the landing gear base 3, the mounting bracket 2 may be in a folded state.

The RTK antenna 4 in the present embodiment may include the functions of positioning, navigation, and the like functions. Since the mounting base 1 may be used to mount the RTK antenna 4, the specific shape of the mounting base 1 may be adapted to the shape of the RTK antenna 4. For example, if the RTK antenna 4 has a disc-shaped structure, the mounting base 1 may also have a circular structure; if the RTK antenna 4 has a rectangular structure, the mounting base 1 may also have a rectangular structure to ensure that the RTK antenna 4 may be stably mounted on the mounting base 1. In one embodiment, the mounting base 1 may be configured to include a mounting plate 101 for carrying or mounting the RTK antenna 4 and a connecting rod 102 that may be connected to the mounting plate 101. Further, the connecting rod 102 may be used to connect with the mounting bracket 2. More specifically, a mounting groove adapted to the connecting rod 102 may be disposed on the mounting bracket 2. When the connecting rod 102 is disposed in the mounting groove, a fixed connection may be established through the connecting parts, and a stable connection between the mounting bracket 2 and the mounting base 1 may be achieved. Of course, those skilled in the art may also design the mounting base 1 to be of other shapes, as long as the mounting base 1 can effectively ensure the mounting of the RTK antenna 4 and the stable connection with the mounting bracket, which will not be described herein.

In addition, the mounting bracket 2 in the present embodiment may be used to establish a connection between the mounting base 1 and the landing gear base 3. More specifically, one end of the mounting bracket 2 may be fixedly connected to the mounting base 1, and the other end of the mounting bracket 2 may be rotatably connected to the landing gear base 3. The specific implementation method of the rotational connection between the mounting bracket 2 and the landing gear base 3 is not limited in the present disclosure. In order to reduce production cost and design difficulty, in one embodiment, the landing gear base 3 may be arranged to be rotatably connected to the mounting bracket 2 via a rotating shaft 6. This implementation may not only use a simple structure which may be easy to implement, but may also effectively ensure the rotational effect between the landing gear base 3 and the mounting bracket 2, thereby achieving the relative rotation between the mounting base 1 and the landing gear base 3. Since the landing gear base 3 may be used to connect the landing gear 5, relative rotation between the RTK antenna 4 and the landing gear 5 may be achieved. More specifically, when it is necessary to ensure the signal quality of the RTK antenna 4, the distance between the RTK antenna and the landing gear 5 may be increased by rotating the mounting bracket 2. That is, the RTK antenna 4 and the landing gear 5 may be respectively located on the upper and lower sides of the landing gear base 3, and the mounting bracket 2 may be in the extended state at this time. When it is necessary to meet the portability requirement of the UAV, the occupied space of the UAV may need to be reduced. As such, the distance between the RTK antenna and the landing gear 5 may be reduced by rotating the mounting bracket 2. That is, the RTK antenna 4 and the landing gear 5 may be located on the same side of the landing gear base 3, and the mounting bracket 2 may be in the folded state at this time. As can be seen through the above process, the present embodiment may be used to effectively meet the portability requirement of the UAV and ensure the performance of the RTK antenna 4.

The mounting bracket 2 of the RTK antenna 4 of the present embodiment may realize the switching between the extended state and the folded state by adjusting the connection position or the connection state of the mounting bracket 2 and the landing gear base 3. More specifically, when the RTK antenna 4 and the landing gear 5 are respectively located on the upper and lower sides of the landing gear base 3, the mounting bracket 2 may be in the extended state; and when the RTK antenna 4 and the landing gear 5 are on the same side of the landing gear base 3, the mounting bracket 2 may be in the folded state. Therefore, the RTK antenna of the present disclosure may be used to effectively meet the portability requirement of the UAV and ensure the performance of the RTK antenna 4. Further, the structure utilization of the antenna mounting bracket may be improved, and the practicality of the antenna mounting bracket may also be ensured, which may be beneficial to the promotion and application of the market.

### Second Embodiment

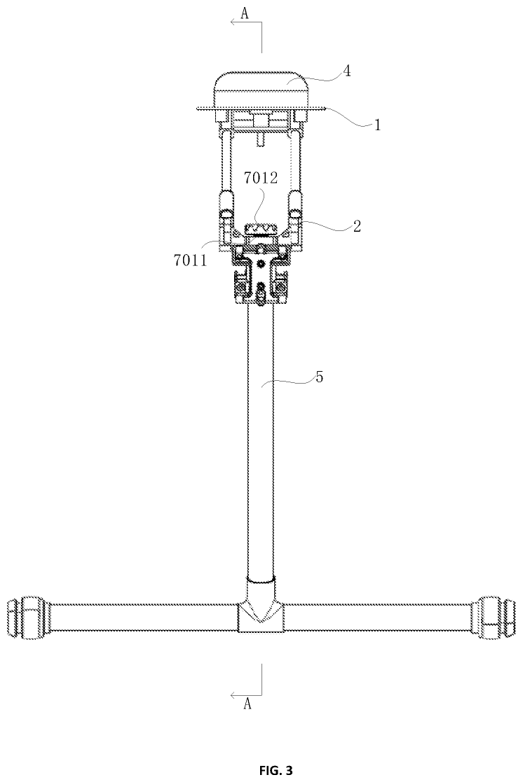

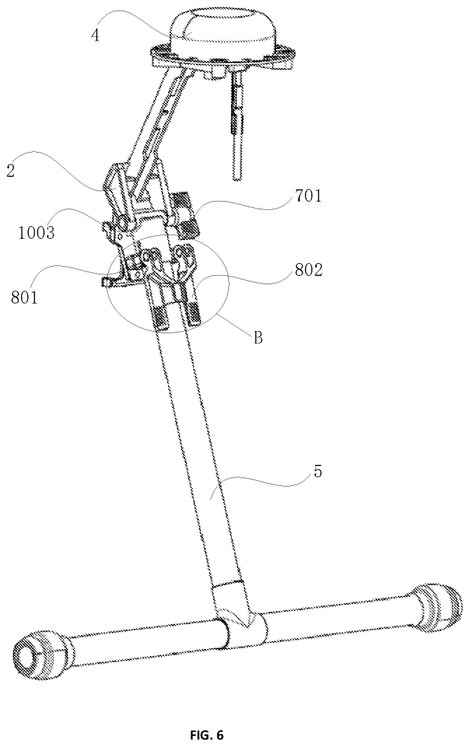

FIG. 3 is a side view of the mounting bracket 2 of the RTK antenna 4 and the landing gear 5 according to an embodiment of the present disclosure; and FIG. 6 is a schematic diagram of another connection structure between the mounting bracket 2 of the RTK antenna 4 and the landing gear 5 according to an embodiment of the present disclosure. Based on the above embodiments, reference will be made to FIGS. 1-3 and 6. While adjusting the connection state between the mounting bracket 2 and the landing gear base 3, when the position has been adjusted to a predetermined position, to ensure that the mounting bracket 2 and the landing gear base 3 remain in the connected state, the antenna mounting bracket may further include a state locking device 7 that may cooperate with the rotating shaft 6, and the state locking device 7 may be used to lock the operating state of the mounting bracket.

The specific shape and structure of the state locking device 7 is not limited in this embodiment, and those skilled in the art may arrange the state locking device 7 according to specific the design requirements. For example, the state locking device 7 may be arranged to include a locking lever set, where one of the locking levers may be engaged with a locking groove of the mounting bracket 2, and the other locking lever may cooperate with a locking groove on the rotating shaft 6. When an operating state of the mounting bracket needs to be locked, the locking levers in the locking lever set may be disposed in the locking groove. As such, the mounting bracket 2 may be prevented from rotating relative to the landing gear base 3. When the operating state of the mounting bracket does not need to be locked, the locking levers in the locking lever set may be disengaged from the locking groove. As such, the mounting bracket 2 may rotate relative to the landing gear base 3.

Alternatively, the state locking device 7 may be arranged to include a fixed knob 701 which may be connected to the rotating shaft 6. When the fixed knob 701 is tightened, the mounting bracket 2 may be in a locked state; and when the fixed knob 701 is loosened, the mounting bracket 2 may be in an unlocked state. More specifically, referring to FIG. 6, the fixed knob 701 may be disposed at one end of the rotating shaft and may be screwed to the rotating shaft 6. When the fixed knob 701 is tightened, the fixed knob 701 may be in close contact with the rotating shaft 6 and the mounting bracket 2. As such, the rotation between the mounting bracket 2 and the rotating shaft 6 may be prevented, and the mounting bracket 2 may be in the locked state. When the fixed knob 701 is loosened, the fixed knob 701 may be separated from the rotating shaft 6 and the mounting bracket 2. As such, the mounting bracket 2 and the rotating shaft 6 may be rotated relative to each other, and the mounting bracket 2 may be in the unlocked state. In addition, in order to facilitate the tightening or loosening operation of the fixed knob 701, a handle may be disposed on the fixed knob to facilitate a user to perform the related operations.

In addition to the two implementation methods mentioned above, in the present embodiment, the state locking device 7 may be further arranged to include a fixed knob 701 connected to the mounting bracket 2. Referring to FIG. 3, the structure of the fixed knob 701 may be different than the fixed knob 701 mentioned above. More specifically, the fixed knob 701 may include a fixed screw 7011 for screwing with the landing gear base 3.

Further, when the fixed screw 7011 is screwed to the landing gear base 3, the mounting bracket 2 may be in the locked state; and when the fixed screw 7011 is separated from the landing gear base 3, the mounting bracket 2 may be in the unlocked state.

In one embodiment, a connection area may be arranged on the landing gear base 3 for the connection with the fixed screw 7011, and an inner surface of the connection area may be threaded. When the fixed screw 7011 is separated from the landing gear base 3, the fixed screw 7011 may be disposed outside the connection area, and the fixed knob 701 may be separated from the landing gear base 3. That is, the mounting bracket 2 may be rotated relative to the landing gear base 3. As such, the mounting bracket 2 may be in the unlocked state. When the fixed screw 7011 is screwed to the connection area, the fixed knob 701 may be fixedly connected to the landing gear base 3, and the fixed knob 701 may be connected to the mounting bracket 2. In one embodiment, a connecting base 301 may be arranged on the mounting bracket 2, and the fixed knob 701 may abut against the connecting base 301. Since the fixed screw 7011 on the fixed knob 701 may be used for the connection with the landing gear base 3, a through hole for the fixed screw 7011 to pass through may also be arranged on the connecting base 301, and the fixed screw 7011 may be screwed to the landing gear base 3 through the through hole. As such, the mounting bracket 2 may be in the locked state. That is, the relative rotation between the mounting bracket 2 and the landing gear base 3 may be prevented.

When the operating state of the mounting bracket 2 is locked by using the fixed screw 701, in order to facilitate the control of the fixed screw 7011, the fixed knob 701 may further include a fixed rotating head 7012 that may be disposed at one end of the fixed screw 7011 for driving the fixed screw 7011 to rotate.

In order to facilitate the user control of the fixed screw 70111 by using the fixed rotating head 7012, a plurality of anti-slip threads may be arranged on the fixed rotating head 7012. In addition, the size of the fixed rotating head 7012 may be configured to be relatively large such that the user may grab on the fixed rotating head 7012, thereby effectively improving the convenience and reliability of the antenna mounting bracket.

The mounting bracket 2 of the RTK antenna 4 of the present disclosure may effectively lock the relative state between the mounting bracket 2 and the landing gear base 3 through the fixed knob 701, thereby ensuring the RTK antenna 4 may be in any relative position (e.g., the RTK antenna 4 and the landing gear 5 may be in a farthest distance state, a closest state, and any position state between them) with respect to the landing gear 5. Further, the fixing method mentioned above may eliminate the virtual position, such that the entire antenna mounting bracket may not vibrate, thereby improving the rigidity of the entire antenna mounting bracket. Furthermore, the positioning accuracy of the RTK antenna 4 may be improved by eliminating the influence of the vibration caused by the virtual position, thereby ensuring the stability and reliability of the RTK antenna 4, improving the practicality of the antenna mounting bracket, and improving the stability and reliability of the antenna mounting bracket.

### Third Embodiment

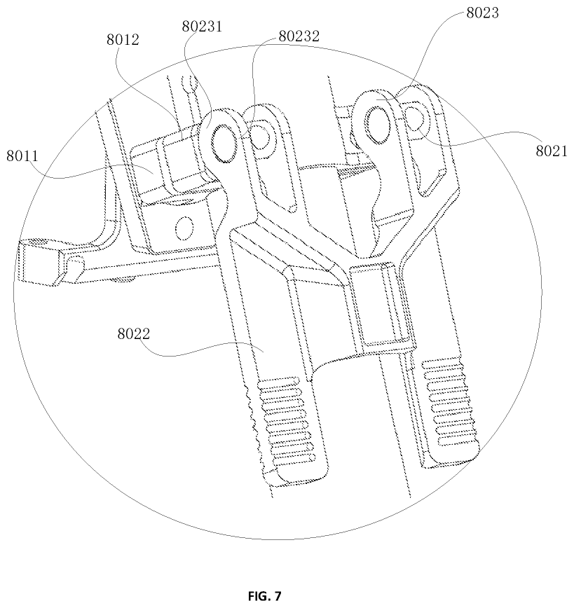

FIG. 7 is an enlarged view of B in FIG. 6. Based on the embodiments mentioned above, reference may be made to FIGS. 1-3 and 6-7. When the landing gear 5 is mounted on the landing gear base 5, to ensure the stability and reliability of the installation of the landing gear 5, the antenna mounting bracket may further include a landing gear quick release latch 8 that may be connected to the landing gear base 3 for locking the connection state of the landing gear 5 and the landing gear base 3.

The landing gear quick release latch 8 in the present disclosure may be detachably connected to the landing gear base 3. More specifically, it may be realized by using a buckle, or the landing gear quick release latch 8 and the landing gear base 3 may be connected by using a screw or a pin, as long as the quick release effect of the landing gear quick lease latch may be achieved. In addition, the landing gear quick release latch 8 may also lock the connection state of the landing gear 5 and the landing gear base 3. More specifically, the landing gear quick release latch 8 may include a clamping mechanism 801, which may be connected to the landing gear base 3 and symmetrically disposed on both sides of the landing gear 5 for clamping/releasing the landing gear 5; and a control mechanism 802, which may be connected to the clamping mechanism 801 for controlling the clamping mechanism.

The specific shape and structure of the clamping mechanism 801 is not limited, and those skilled in the art may arranged it based on specific design requirements. For example, the clamping mechanism 801 may be arranged as a clip-on structure, that is, the clamping mechanism 801 may include clips symmetrically disposed on both sides of the landing gear 5. When the distance between the clips on both sides increase, the landing gear 5 may be released. Alternatively, the clamping mechanism 801 may be arranged to include a first hoop 8011, a second hoop 8012 connected to the first hoop 8011, and the first hoop 8011 and the second hoop 8012 may move relative to each other.

In particular, when the gap between the first hoop 8011 and the second hoop 8012 increases, the clamping mechanism 801 may release the landing gear 5; and when the gap between the first hoop 8011 and the second hoop 8012 decreases, the clamping mechanism 801 may clamp the landing gear 5

It should be noted that the first hoop 8011 and the second hoop 8012 may have the same shape and structure. Since the first hoop 8011 and the second hoop 8012 may move relative to each other, the first hoop 8011 and the second hoop 8012 may be connected by an elastic member, and the elasticity and the restoring force of the elastic member may allow the first hoop 8011 and the second hoop 8012 to move relative to each other. When the elastic member is in a compressed state, the gap between the first hoop 8011 and the second hoop 8012 may be reduced, that is, the first hoop 8011 and the second hoop 8012 may be in a state close to each other. Since the first hoop 8011 is close to the second hoop 8012, the space between the hoops on both sides may also be reduced, thereby allowing the clamping mechanism 801 to clamp to the landing gear 5. When the elastic member is in an extended state, the gap between the first hoop 8011 and the second hoop 8012 may be increased, that is, the first hoop 8011 and the second hoop 8012 may be in a state away from each other. Since the first hoop 8011 is away from the second hoop 8012, the space between the hoops on both sides may also be increased, thereby allowing the clamping mechanism 801 to release the landing gear 5.

Of course, those skilled in the art may also achieve the relative movement between the first hoop 8011 and the second hoop 8012 by using other methods. In one embodiment, the first hoop 8011 and the second hoop 8012 may be arranged to be connected by a pulling shaft, and the first hoop 8011 and the second hoop 8012 may be axially moved along the pulling shaft.

More specifically, the first hoop 8011 and the second hoop 8012 may be sleeved on the pulling shaft. Referring to FIG. 7, the first hoop 8011 may be adjacent to a body connection portion 9, and the second hoop 8012 may be adjacent to the control mechanism 802. Therefore, when the control mechanism 802 abuts against the second hoop 8012, a pushing force may be generated, and the pushing force may cause the second hoop 8012 to move in the direction of the first hoop 8011 along the pulling shaft, thereby reducing the space between the first hoop 8011 and the second hoop 8012. Since the first hoop 8011 is close to the second hoop 8012, the space between the hoops on both sides may also be reduced, thereby allowing the clamping mechanism 801 to clamp to the landing gear 5. When the control mechanism 802 is separated from the second hoop 8012, the second hoop 8012 may move in the direction away from the first hoop 8011 along the pulling shaft due to the withdrawal of the pushing force, thereby increasing the space between the first hoop 8011 and the second hoop 8012. Since the first hoop 8011 is away from the second hoop 8012, the space between the hoops on both sides may also be increased, thereby allowing the clamping mechanism 801 to release the landing gear 5. As such, the operation of the clamping or releasing of the landing gear 5 by using the clamping mechanism 801 may be realized, and the stability and reliability of the connection between the landing gear 5 and the landing gear base 3 may be ensured.

In addition, the specific shape and structure of the control mechanism 802 is not limited in the present disclosure, and those skilled in the art may arbitrarily configure it based on the functions it may be used to realize. In one embodiment, the control mechanism 802 may include a rotating shaft 8021, and a cam 8023 that may be in contact with the clamping mechanism 801 may be disposed on the rotating shaft 8021. The cam 8023 may include a first wheel portion 80231 and a second wheel portion connected to the first wheel portion 80231, and the inner diameter of the first wheel portion 80231 may be larger than the inner diameter of the second wheel portion 80232.

When the first wheel portion 80231 of the cam abuts against the clamping mechanism 801, the clamping mechanism 801 may clamp to the landing gear 5; and when the second wheel portion 80232 of the cam 8023 is in contact with the clamping mechanism 801, the clamping mechanism 801 may release the landing gear 5.

Further, the first wheel portion 80231 may be integrally formed with the second wheel portion 80232. It should be noted that the cam 8023 may have an irregular elliptical structure, that is, the inner diameter of the first wheel portion 80231 may be larger than the inner diameter of the second wheel portion 80232. In addition, the cam 8023 may be used for contacting the second hoop 8012 in the clamping mechanism 801, and the cam 8023 may be rotated along the rotating shaft 8021. Therefore, when the cam 8023 is rotated until the first wheel portion 80231 abuts against the clamping mechanism 801, that is, the first wheel portion 80231 is abutting against the second hoop 8012, since the size of the first wheel portion 80231 is relatively large, a pushing force may be generated. The pushing force may cause the second hoop 8012 to move in the direction of the first hoop 8011 along the pulling shaft, thereby reducing the space between the first hoop 8011 and the second hoop 8012, and allowing the clamping mechanism 801 to clamp to the landing gear 5. Similarly, when the cam 8023 is rotated until the second wheel portion 80232 is in contact with the clamping mechanism 801, since the size of the second wheel portion 80232 is relatively small, the pushing force for pushing the movement of the second hoop 8012 may be removed. In this case, the second hoop 8012 may move in the direction away from the first hoop 8011 along the pulling shaft, thereby increasing the space between the first hoop 8011 and the second hoop 8012, and allowing the clamping mechanism 801 to release the landing gear 5.

In one embodiment, in order to facilitate the control of rotation of the cam 8023 along the rotating shaft 8021, the control mechanism 802 may further include a handle 8022. The handle 8022 may be connected to the cam 8023 for driving the cam 8023 to rotate along the rotating shaft 8021.

The handle 8022 of the present embodiment may be connected to the cam 8023 through a connecting member, which may be a screw, a bolt, a stud, an adhesive, or the like. In one embodiment, the handle 8022 and the cam 8023 may be integrally connected, which may effectively ensure the stability and reliability of the connection between the handle 8022 and the cam 8023. Further, when the user moves the position of the handle 8022, the movement of the handle 8022 may drive the cam 8023 to rotate along the rotating shaft 8021, thereby ensuring the convenient and reliable control of the rotation of the cam 8023, and further improving the utility of the antenna mounting bracket.

### Fourth Embodiment

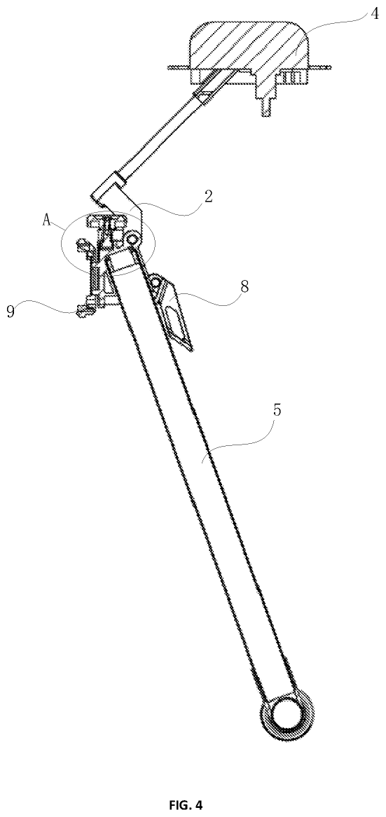

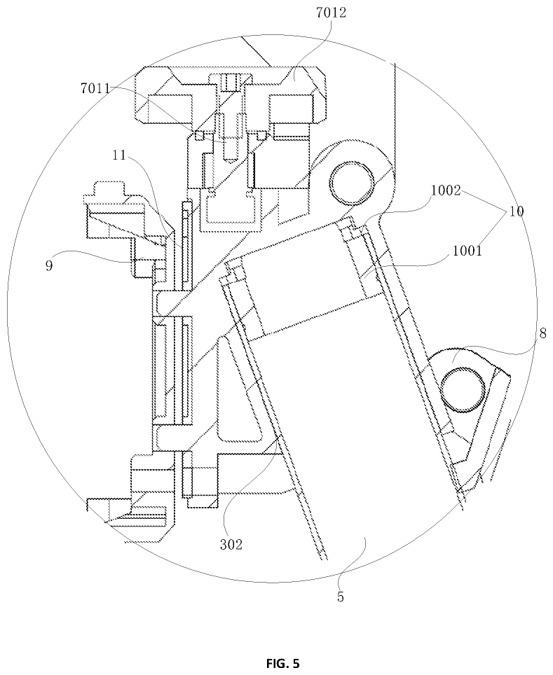

FIG. 4 is a cross-sectional view along line A-A of FIG. 3; and FIG. 5 is an enlarged view of A in FIG. 4. Based on the above embodiments and referring to FIGS. 1-7, the antenna mounting bracket may be used to carry the RTK antenna 4, and the RTK antenna 4 may be installed on the UAV. Therefore, in order to facilitate the installation of the RTK antenna 4 on the UAV, the body connection portion 9 may be disposed on the landing gear base 3, and the body connection portion 9 may be used for the connection with the body of the UAV.

In particular, the body connection portion 9 and the landing gear base 3 may be connected by a connecting member. In one embodiment, the body connection portion 9 and the landing gear base 3 may be disposed to be connected by a connecting member such as a screw, a bolt, or a stud. That is, the body connection portion 9 and the landing gear base 3 may be screwed together. As such, it may be convenient to facilitate the installation and disassembly of the body connection portion 9 and the landing gear base 3, thereby making the maintenance and management more convenient for the user. In addition, in order to improve the stability and reliability of the connection between the body connection portion 9 and the landing gear base 3, a spacer 11 may be disposed between the body connection portion 9 and the landing gear base 3. The spacer 11 may not only provide the effect of increasing friction and reducing slippage, but may also provide a waterproof and dustproof effect. Since some controllers may be disposed in the landing gear base 3 for the communication and data exchange with the UAV, the use of the waterproof and dustproof spacer 11 may effectively ensure the safety and reliability of the controllers, and also improve the safety and reliability of the antenna mounting bracket.

### Fifth Embodiment

Based on the above embodiments and referring to FIGS. 1-7, generally, the landing gear 5 may be composed of a connecting rod of a cylindrical structure. When one end of the landing gear 5 is attached to the landing gear base 3, the stable connection between the landing gear 5 and the landing gear base 3 may be effectively ensured by the landing gear quick release latch 8 mentioned above, but the landing gear 5 cannot be guaranteed not to rotate by itself. When the landing gear 5 performs certain rotation movements, it may cause the UAV to be unstable during landing. Therefore, in order to prevent the self-rotation movement of the landing gear 5 connected to the landing gear base 3, the antenna mounting bracket may further include a rotation positioning mechanism 10. The rotation positioning mechanism 10 may be connected to the landing gear base 3 for preventing the landing gear 5 from rotating relative to the landing gear base 3.

The specific shape and structure of the rotation positioning mechanism 10 is not limited, and those skilled in the art may arbitrarily configure it based on the functions it may be used to realize. In one embodiment, referring to FIG. 5, the rotation positioning mechanism 10 may be arranged to include a plurality of positioning bases 1001 uniformly disposed inside the sleeve 302. The sleeve 302 may be disposed on the landing gear base 3 for mounting the landing gear 5, and the positioning bases 1001 may be adapted to cooperate with a plurality of positioning areas on the landing gear 5.

It should be noted that the sleeve 302 may be disposed on the landing gear base 3, and the size of the sleeve 302 may be adapted to the size of the landing gear 5 for mounting the landing gear 5. Further, a plurality of positioning bases 1001 may be uniformly disposed at the top of the sleeve 302, and the positioning bases 1001 may have a cylindrical structure or a strip structure. Generally, 3, 4, or 5 positioning bases 1001 may be arranged. It should be noted that since the positioning base 1001 may cooperate with a positioning area on top of the landing gear 5, the number of positioning areas may be the same as the number of position bases 1001. When the positioning base 1001 is located in the positioning area, it may ensure that the landing gear 5 may not rotate relative to the landing gear base 3. To ensure that the positioning base 1001 may be stably disposed in the positioning area, the positioning base 1001 may also be connected to the landing gear 5 through the connecting member. Alternatively, the positioning area may also be arranged as a groove structure so the positioning base 1001 may be disposed in the groove without being easily detached, as long as the stable cooperative between the positioning base 1001 and the positioning area can be effectively ensure, and no further details are provided herein.

To further improve the positioning effect on the landing gear 5, the rotation positioning mechanism 10 may further include a plurality of limiting protrusions 1002. The limiting protrusions 1002 may be disposed on one side of the positioning base 1001 for limiting the landing gear 5. The limiting protrusions 1002 and the positioning base 1001 may be disposed perpendicular to each other, and the limiting protrusions 1002 may be used for placing the landing gear 5 to drive the positioning base 1001 to rotate together, thereby further ensuring the positioning of the landing gear 5.

By arranging the rotation positioning mechanism 10 connected to the landing gear base 3, more specifically, the rotation positioning mechanism 10 may include the positioning bases 1001, and through the cooperation between the positioning bases 1001 and the positioning areas, the stable connection between the landing gear 5 and the landing gear 5 may be ensured, thereby preventing the self-rotation of the landing gear 5, and further improving the safety and reliability of the antenna mounting bracket.

In addition to arranging the rotation positioning mechanism 10 to include the positioning bases 1001, in order to reduce the difficulty of the production process and increase the production efficiency, the rotation positioning mechanism 10 may include a limiting groove 1003. The limiting groove 1003 may be disposed at one end of the landing gear 5 for cooperating with the rotating shaft 6 to prevent the self-rotation of the landing gear 5.

The limiting groove 1003 of the present embodiment may have a semi-circular structure for cooperating with the outer shape of the rotating shaft 6. Referring to FIG. 6, since the rotating shaft 6 has a cylindrical structure, when the state locking device 7 locks the operating state of the mounting bracket 2, the landing gear 5 may not move relative to the RTK antenna 4. In order to prevent the landing gear 5 from performing the self-rotation movement, that is, the horizontal direction in FIG. 6, the mounting bracket 2 and the rotating shaft 8021 may be in a locked state, therefore, the rotating shaft 8021 may not move. The rotating shaft 8021 may be disposed in the limiting groove 1003. When the landing gear 5 performs the self-rotation movements, the limiting groove 1003 is driven to move, and the rotating shaft 8021 that may not move may prevent the limiting groove 1003 from moving, thereby preventing the self-rotation movements of the landing gear 5, ensuring the stability and reliability of the use of the landing gear 5, and improving the utility of the antenna mounting bracket.

### Sixth Embodiment

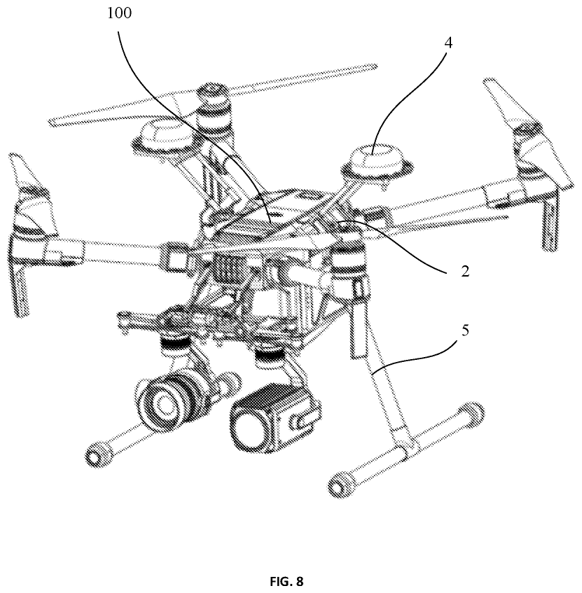

FIG. 8 is a schematic structural diagram of an UAV according to an embodiment of the present disclosure. Referring to FIG. 8, the present embodiment provides an UAV, the UAV may include a body 100; a landing gear 5 for supporting the body 100 during landing of the UAV; and an antenna mounting bracket connected to the landing gear 5, where the antenna mounting bracket may be the antenna mounting bracket in any one of Embodiments 1-5 mentioned above.

The specific shape, structure, and function effects of the antenna mounting bracket in the present embodiment may be the same as the specific shape, structure, and function effects of the antenna mounting bracket in the First Embodiment to the Fifth Embodiment. For details, refer to the descriptions provided above, and details are note described herein again.

The UAV of the present embodiment, through the arrangement of the mounting bracket 2 of the RTK antenna 4 may realize the switching between the extended state and the folded state of the mounting bracket by adjusting the connection position or the connection state of the mounting bracket 2 and the landing gear base 3. More specifically, when the RTK antenna 4 and the landing gear 5 are respectively located on the upper and lower sides of the landing gear base 3, the mounting bracket 2 may be in the extended state; and when the RTK antenna 4 and the landing gear 5 are on the same side of the landing gear base 3, the mounting bracket 2 may be in the folded state. Therefore, the RTK antenna of the present disclosure may be used to effectively meet the portability requirement of the UAV and ensure the operational quality of the RTK antenna 4. Further, the structure utilization of the antenna mounting bracket may be improved, and the practicality of the antenna mounting bracket may also be ensured, which may be beneficial to the promotion and application of the market.

It should be noted that the foregoing embodiments are merely intended for describing the technical solutions of the present disclosure instead of limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. An UAV, comprising:
a body;
a landing gear for supporting the body when the UAV is landing; and
an antenna mounting bracket connected to the landing gear, the antenna mounting gear including:
a mounting base for mounting an RTK antenna;
a mounting bracket that is connected to the mounting base;
a landing gear base for connecting to the landing gear, the landing gear base being rotatably connected to the mounting bracket;
wherein the mounting bracket is in an extended state when the RTK antenna and the landing gear are respectively located on an upper and a lower side of the landing gear base; and the mounting bracket is in a folded state when the RTK antenna and the landing gear base are on the same side of the landing gear base.

2. The UAV of claim 1, wherein the landing gear base is rotatably connected to the mounting bracket by a rotating shaft.

3. The UAV of claim 2, wherein the antenna mounting bracket further includes a locking device that is cooperating with the rotating shaft for locking in an operating state of the mounting bracket.

4. The UAV of claim 3, wherein the locking device includes a fixed knob connected to the rotating shaft, the mounting bracket being in a locked state when the fixed knob is tightened and the mounting bracket being in an unlocked state when the fixed knob is loosened.

5. The UAV of claim 3, wherein the locking device includes a fixed knob connected to the mounting bracket, the fixed knob includes a fixed screw for screwing with the landing gear base; the mounting bracket is in a locked state when the fixed screw is screwed to the landing gear base; and the mounting bracket is in an unlocked state when the fixed screw is separated from the landing gear base.

6. The UAV of claim 5, wherein the fixed knob further includes a fixed rotating head connected to the fixed screw, and the fixed rotating head is disposed at an end of the fixed screw for driving the fixed screw to rotate.

7. The UAV of claim 5, wherein a connecting base is disposed on the mounting bracket, and the fixed knob abuts against the connecting base.

8. The UAV of claim 7, wherein a through hole for the fixed screw to pass through is disposed on the connecting base.

9. The UAV of claim 1, further including:
a landing gear quick release latch connected to the landing gear base for locking in a connection state of the landing gear and the landing gear base.

10. The UAV of claim 9, wherein the landing gear quick release latch includes:
a clamping mechanism connected to the landing gear base and symmetrically disposed on both sides of the landing gear for clamping and releasing the landing gear; and
a control mechanism connected to the clamping mechanism for controlling the clamping mechanism.

11. The UAV of claim 10, wherein the clamping mechanism includes:
a first hoop and a second hoop connected to the first hoop, the first hoop and the second hoop moving relatively to each other,
the clamping mechanism releasing the landing gear when a gap between the first hoop and the second hoop increases; and the clamping mechanism clamping the landing gear when the gap between the first hoop and the second hoop decreases.

12. The UAV of claim 11, wherein the first hoop and the second hoop are connected by a pulling shaft, and the first hoop and the second hoop are axially movable along the pulling shaft.

13. The UAV of claim 10, wherein the control mechanism includes:
a rotating shaft, the rotating shaft including a cam connected to the clamping mechanism, the cam includes a first wheel portion and a second wheel portion connected to the first wheel portion, and an inner diameter of the first wheel portion is larger than an inner diameter of the second wheel portion;
the clamping mechanism clamping to the landing gear when the first wheel portion of the cam abuts against the clamping mechanism; and the clamping mechanism releasing the landing gear when the second wheel portion of the cam is in contact with the clamping mechanism.

14. The UAV of claim 13, wherein the control mechanism further includes a handle connected to the cam for driving the cam to rotate along the rotating shaft.

15. The UAV of claim 2, wherein a body connection portion is disposed on the landing gear base, and the body connection portion is connected to the body of the UAV.

16. The UAV of claim 15, wherein the body connection portion is screwed onto the landing gear base.

17. The UAV of claim 1, further including:
a rotation positioning mechanism connected to the landing gear base for preventing the rotation of the landing gear relative to the landing gear base.

18. The UAV of claim 17, wherein the rotation positioning mechanism includes a plurality of positioning bases uniformly disposed inside a sleeve, the sleeve being disposed on the landing gear base for mounting the landing gear; and the positioning bases are adapted to cooperate with a positioning area on the landing gear.

19. The UAV of claim 18, wherein the rotation positioning mechanism further includes a plurality of limiting protrusions disposed on one side of the positioning base for limiting the landing gear.

20. The UAV of claim 17, wherein the rotation positioning mechanism includes a limiting groove disposed at an end of the landing gear for cooperating with the rotating shaft to prevent the landing gear from rotating.
